(19) United States
(12) Patent Application Publication
(10) Pub. No.: US 2007/0149016 A1
(43) Pub. Date: Jun. 28, 2007

(54) Electrical connector assembly with pick up device

(75) Inventors: Zhan-Jun Xu, Shenzhen (CN); Qing-Feng Wang, Shenzhen (CN); Fu-Jin Peng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/645,409

(22) Filed: Dec. 26, 2006

(30) Foreign Application Priority Data
Dec. 26, 2005 (CN) 200520140397.0

(51) Int. Cl. H01R 13/62

(52) U.S. Cl. 439/157

(57) ABSTRACT

An electrical connector assembly according to a preferred embodiment includes an electrical connector (1) and a pick up device (5) engageably mounted onto the electrical connector. The electrical connector includes a rear head portion, where an actuator (4) is rotatably held therein, and a front tail portion opposite to the head portion. The pick up device has a front covering portion (58) extending in a forward and downward direction relative to the front tail portion. Thus, during a SMT process used for soldering the electrical connector to a printed circuit board, temperature in difference is prevented between the head portion and the tail portion due to their different heat absorption characteristic, thereby avoiding solder wicking and/or bridging of the tail portion.

### BACKGROUND OF THE INVENTION

1. FIELD OF THE INVENTION

The present invention relates to the art of electrical connectors, and more particularly to an electrical connector assembly including a pick up device for facilitating transportation of the electrical connector assembly.

2. DESCRIPTION OF THE RELATED ART

Electrical connectors have been developed in different types, such as an LGA socket, a BGA socket, etc., for establishing electrical connection between two separate circuit boards. The electrical connectors are often manipulated and transported for positioning on electrical apparatus as, for example, on a printed circuit board by means of vacuum suction nozzles. In the case of BGA sockets, a pick up device is typically employed to have a flat upper surface for being sucked by vacuum suction nozzles for transportation, before the BGA socket is soldered to the printed circuit board by a surface mounting technology (SMT) process.

One conventional electrical connector assembly, as shown in FIGS. 4 and 5, includes an electrical connector 10 and a pick up cap 13 mounted onto the electrical connector 10. The electrical connector 10 includes an insulative housing 11, a plurality of terminals (not shown), a cover 12 and an actuator 14. The terminals 15 are held within the insulative housing 11, and have lower portions 151 adapted for being soldered to the printed circuit board by the SMT process. The cover 12 is moveably mounted onto the insulative housing 11. The cover 12 defines at a central section thereof an opening 121 for a pick up device to be engaged on a periphery portion of the opening 121. The cover 12 together with the insulative housing 11 is further formed with a rear head portion and a front tail portion, the rear head portion defining an interior space (not shown) for receiving the actuator 14 therein. The actuator 14, typically in the form of a cam lever, has a portion thereof (not shown) rotatably held within the head portion for driving the cover to move relative to the insulative housing.

The pick up cap 13 is engageably mounted onto the cover 12. The pick up cap 13 has a flat upper surface and a lower surface, with several through holes 134 extending through the flat upper surface and the lower surface. The upper surface defines a section for being sucked by the vacuum suction nozzle (not shown). A plurality of projections 132, adjacent the respective through holes 134, is arranged to extend downwardly from the lower surface for engaging on the peripheral portion of the opening 121 so as to mount the pick up cap 13 to the electrical connector 10. Typically, the pick up cap 13 is designed to cover only a middle zone of the insulative housing 11 including that opening 121, which is necessary while merely enough for the suction of the vacuum nozzle.

A problem with using the electrical connector assembly during the SMT process, is that there is difference in temperature between the front tail portion and the rear head portion, resulting in solder wicking and/or bridging phenomenon at the front tail portion. This is so because the rear head portion, where metallic components may be embedded therein, is apt to gain more heat than the front tail portion. This will directly result in electrical connection failure between the electrical connector and the printed circuit board at the bottom surface of the insulative housing 13.

### SUMMARY OF THE INVENTION

An electrical connector assembly according to a preferred embodiment includes an electrical connector and a pick up device engageably mounted onto the electrical connector. The electrical connector includes an insulative housing being of a rectangular shape, a plurality of terminals, a cover and an actuator. The terminals are held within the insulative housing, and each have a lower portion adapted to be soldered to a printed circuit board by a SMT process. The cover is moveably mounted onto the insulative housing, and together with the insulative housing defines a rear head portion and a front tail portion. The actuator is rotatably held in the head portion. The pick up device is engageably mounted onto the cover, and has a front covering portion extending in a forward and downward direction relative to the front tail portion. Thus, during the SMT process used for soldering the electrical connector to the printed circuit board, part of external heat is blocked from entering the front tail portion, thus counterbalancing temperature difference between the rear head portion and the front tail portion due to the more heat absorption of the rear head portion. Therefore, solder wicking or bridging at a mounting bottom surface, where the terminals are soldered to the printed circuit board, is prevented, thereby avoiding electrical connection failure between the electrical connector and the printed circuit board.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an assembled, isometric view of an electrical connector assembly according to a preferred embodiment of the present invention, showing an electrical connector at a fully closed position;

FIG. 2 is an exploded, isometric view of the electrical connector assembly of FIG. 1, but showing a pick up device disengageable with an electrical connector; and

FIG. 3 is an isometric view of the pick up device of FIG. 1, but viewed from another aspect.

FIG. 4 is an assembled, isometric view of part of a conventional electrical connector assembly, showing a pick up cap disengageable with an electrical connector; and

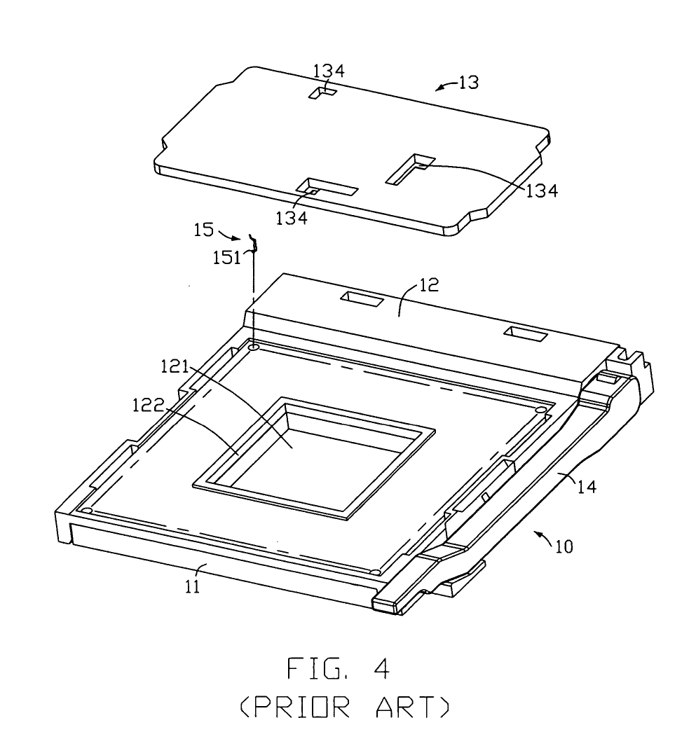

FIG. 5 is an isometric view of the pick up cap of FIG. 4, but viewed from another aspect.

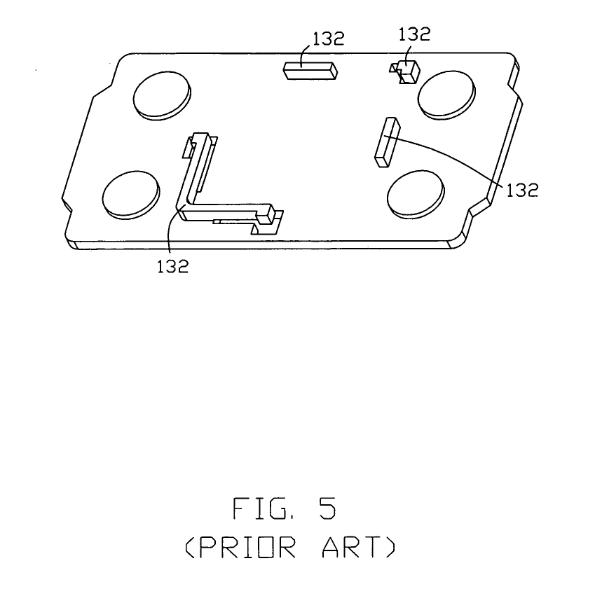

### DETAILED DESCRIPTION OF PREFERRED EMBODIMENT

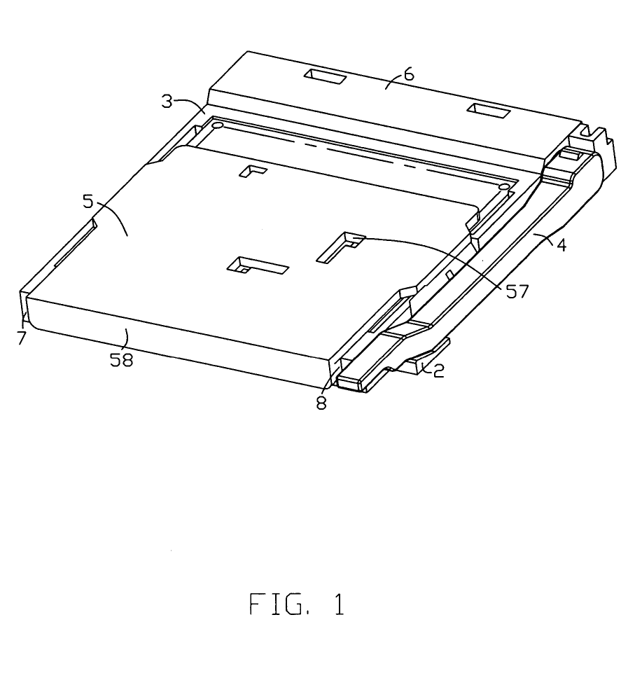

Referring to FIGS. 1 to 3, an electrical connector assembly according to the preferred embodiment is shown for electrical connection to a printed circuit board (not shown). The electrical connector assembly includes an electrical connector 1 and a pick up device 5 detachably and engageably mounted onto the electrical connector 1.

The electrical connector 1 includes a rectangular insulative housing 2, a plurality of terminals 9, a cover 3 and a lever-like actuator 4. The terminals 9 are held within the insulative housing 2, and each has a lower portion 91 adapted for being soldered to the printed circuit board by the SMT process. The cover 3 is slidably mounted onto the insulative housing 2 and capable of being back and forth moveable with respect to the housing 2 along a lengthwise direction. The cover 3 together with the housing 2 defines a first end portion or rear head portion 6, a second end portion or front tail portion 7 opposite to the rear head portion 6, and a middle portion including a through hole 31 between the rear head portion 6 and the front tail portion 7 for the pick up device 5 to be interferingly engaged with a periphery edge 32 of the opening 121 (to be later described). The rear head portion 6 defines an interior space (not shown) for receiving the lever-like actuator 4 in a known manner, while the front tail portion 7 has none of components accommodated therein. The rear head portion 6 in dimension is larger than the front tail portion 7 in at least one of a vertical direction and a horizontal direction. In this embodiment, the actuator 4 is in the form of a lever, and includes an actuating section (not shown) rotatably held in the rear head portion 6. Typically, the actuating section is moveable about a horizontal axis so as to drive the cover 3 to move relative to the insulative housing 2 along the lengthwise direction. In another alternative embodiments, the actuator 4 may be of a cam shape, and have a portion moveable about a vertical axis in order to drive the cover 3 to move relative to the insulative housing 2. However, it should be noted that, the actuator 4 could be designed to have a portion moveable about any suitable predetermined axis to drive the cover 3 to move relative to the insulative housing 2 along a predetermined path.

The pick up device 5 is generally in the form of a cap or cover. In this embodiment, the pick up cap 5 includes a main body 56 and a front cover portion 58 adjacent the front tail portion 7. The main body 56 is configured to extend laterally between opposite sides of the cover 3, and have a flat upper surface and an opposite lower surface parallel to the upper surface. The upper surface typically includes three separate through holes 57 to jointly define a region therebetween for facilitating the suction of the vacuum nozzle. Projections 53, adjacent the respective through holes 57, are arranged to extend downwardly from the lower surface for interferingly engaging on the periphery edge 32 of the middle through hole 31 so as to mount the pick up cap 5 to the electrical connector 1. The front cover portion 58 is located forwardly of the tail portion 7 and then extends downwardly along at least part of a transverse side of the front tail portion 7. In this embodiment, the front cover portion 58 extends in a forward and downward direction relative to the whole front tail portion 7. It is noted that, in this embodiment, when the electrical connector 1 is shown to be at a fully closed position, the front cover portion 58 almost abuts against an exterior edge of the front tail portion 7.

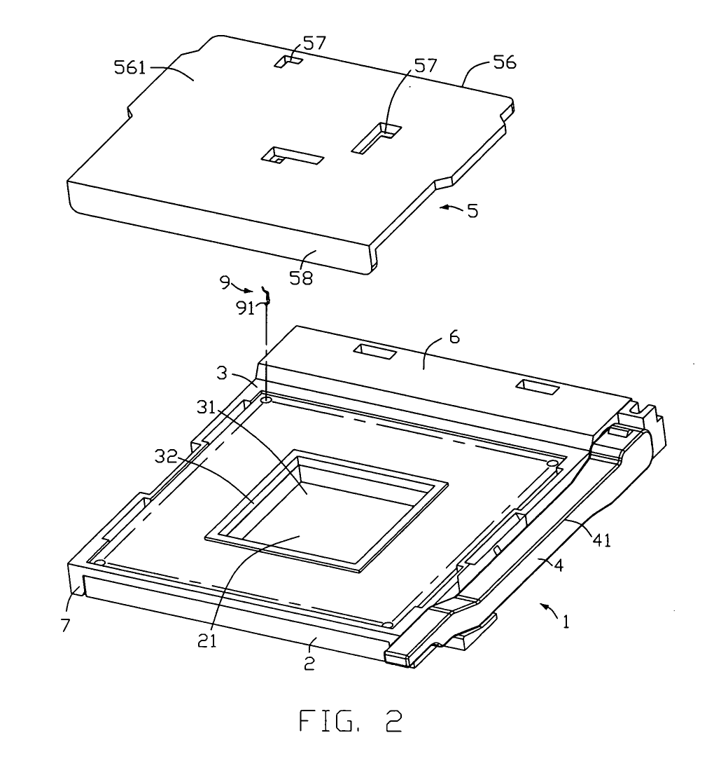

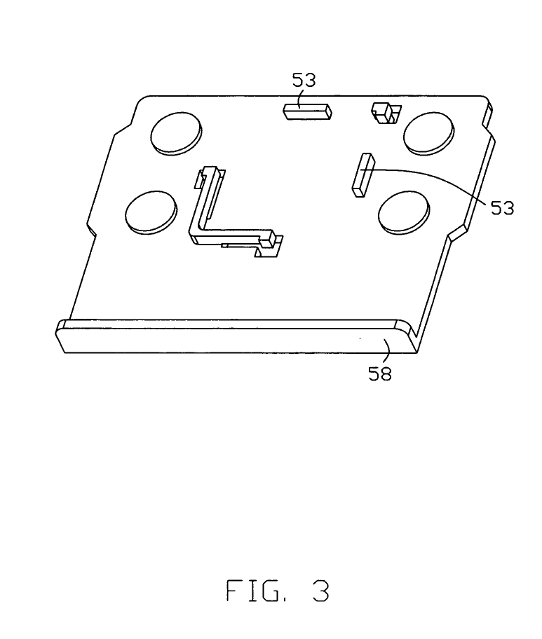

Referring still to FIGS. 2 and 3, in assembly of the electrical connector assembly, with the electrical connector 1 pre-assembled, the pick up cap 5 is engageably mounted onto the electrical connector 1 by the projections 53 interferingly engageable with the periphery edge 32 of the cover 3. As such, the front cover portion 58 of the pick up cap 5 is located forwardly beyond the front tail portion 7 such that part of external heat, during the SMT process, is blocked from entering the front tail portion 7, thus counterbalancing temperature difference between the rear head portion 6 and the front tail portion 7 due to the more heat absorption of the rear head portion 6. Therefore, solder wicking or bridging at a mounting bottom surface, where the terminals are soldered to the printed circuit board, is prevented, thereby avoiding electrical connection failure between the electrical connector 1 and the printed circuit board.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. An electrical connector assembly comprising:
an insulative housing being of a rectangular shape;
a plurality of terminals held within the insulative housing, each having a lower portion adapted to be soldered to a printed circuit board;
a cover moveably mounted onto the insulative housing, the cover together with the insulative housing defining a rear head portion and a front tail portion;
an actuator rotatably held in the head portion; and
a pick up device engageably mounted onto the cover and having a front covering portion, the front covering portion blocking a forward end of the front tail portion.

2. The electrical connector assembly as recited in claim 1, wherein the rear head portion in dimension is larger than the front tail portion in at least one of a vertical direction and a horizontal direction.

3. The electrical connector assembly as recited in claim 1, wherein said front covering portion extends along at least one part of a transverse side of the front tail portion.

4. The electrical connector assembly as recited in claim 1, wherein the actuator is moveable around a horizontal axis to drive the cover to move relative to the insulative housing.

5. The electrical connector assembly as recited in claim 4, wherein the cover is back and forth moveable with respect to the insulative housing along a lengthwise direction.

6. The electrical connector assembly as recited in claim 5, wherein the actuator has a portion held within the rear head portion to be rotatable around a horizontal axis so as to drive the cover to move relative to the insulative housing along the lengthwise direction.

7. An electrical connector assembly comprising:
a substantially rectangular connector body defining a first end portion, an opposite second end portion, and a main body extending between the first end portion and the second end portion, said first end portion in dimension being larger than said second end portion in at least one of a vertical direction and a horizontal direction;
a plurality of terminals held within the main body, each having a lower portion adapted to be soldered to a printed circuit board; and
a cap member engageably mounted onto the connector, the cap member having a covering section extending downwardly and along at least part of a transverse side of said second end portion.

8. The electrical connector assembly as recited in claim 7, further comprising an actuator held within said second end portion.

9. The electrical connector assembly as recited in claim 8, wherein the actuator comprises a lever.

10. The electrical connector assembly as recited in claim 9, wherein the lever has an actuating portion held in the second end portion and to be moveable around a horizontal axis.

11. The electrical connector assembly as recited in claim 7, further comprising a cover moveably mounted onto the main body.

12. The electrical connector assembly as recited in claim 11, wherein the cover is back and forth moveable with respect to the main body along a lengthwise direction.

13. The electrical connector assembly as recited in claim 12, further comprising an actuator having an actuating portion rotatably held in the second end portion so as to drive the cover to move along the lengthwise direction.

14. The electrical connector assembly as recited in claim 13, wherein the actuating portion is moveable around a horizontal axis.

15. The electrical connector assembly as recited in claim 14, wherein the actuator comprises a lever.

16. An electrical connector assembly comprising:
an insulative housing being of a regular shape;
a plurality of terminals held within the insulative housing, each having a lower portion adapted to be mounted to a printed circuit board;
a cover moveably mounted onto the insulative housing, the cover defining a forward facing front edge thereof;
an actuator rotatably held in the head portion; and
a pick up device defining a plate with at least one attachment device engageably mounted onto the cover and having a front covering portion downwardly extending from a front edge of the plate, the front covering portion shielding the front edge of the cover.
